(19) United States
(12) Patent Application Publication
(10) Pub. No.: US 2015/0246594 A1
(43) Pub. Date: Sep. 3, 2015

(54) AIR CONDITIONER FOR VEHICLE

(71) Applicant: DENSO CORPORATION, Kariya-city (JP)

(72) Inventors: Yoshiharu Endoh, Kariya-city (JP); Yasuhiro Yokoo, Kariya-city (JP); Terukazu Higuchi, Okazaki-city (JP)

(21) Appl. No.: 14/428,291

(22) PCT Filed: Sep. 2, 2013
(86) PCT No.: PCT/JP2013/005164

§ 371 Date: Mar. 13, 2015

(30) Foreign Application Priority Data
Sep. 18, 2012 (JP) 2012-204518

(51) Int. Cl. B60H 1/32

(52) U.S. Cl. CPC B60H 1/321

(57) ABSTRACT

When a detection temperature detected by a refrigerant temperature sensor-is lower than a threshold value, it is determined to be YES at a frosting determining section as an exterior heat exchanger is frosted, an electric control unit reduces an air volume to be blown by an electric blower at an air-volume controlling section. Accordingly, an air volume blown from openings through the heating heat exchanger is reduced. In the result, an air volume passing through the heating heat exchanger can be reduced in a state where the heating heat exchanger heats an inside air using high-temperature high-pressure refrigerant when the exterior heat exchanger is frosted. Accordingly, a temperature of air after passing through the heating heat exchanger can be prevented from decreasing.

### CROSS REFERENCE TO RELATED APPLICATION

This application is based on Japanese Patent Application No. 2012-204518 filed on Sep. 18, 2012, the contents of which are incorporated herein by reference in its entirety.

### TECHNICAL FIELD

The present disclosure relates to an air conditioner for a vehicle.

### BACKGROUND OF ART

Conventionally, an air conditioner for vehicle has an exterior heat exchanger in which refrigerant exchanges heat with air from an outside of a passenger compartment (i.e., outside air) and an interior heat exchanger in which refrigerant exchanges heat with air from an inside of the passenger compartment (i.e., inside air). The air conditioner for vehicle further has a refrigerant cycle that is a vapor compression type and constitutes a cycle heating a ventilation air by absorbing heat in the exterior heat exchanger and radiating the heat in the interior heat exchanger. When the exterior heat exchanger is frosted, the refrigerant cycle is operated such that a defrost operation for the exterior heat exchanger is performed by absorbing heat in the interior heat exchanger and radiating the heat in the exterior heat exchanger (for example, see Patent Document 1).

An air-conditioning device for an electric vehicle is constituted a four-way valve to be switchable between (i) a heating cycle in which refrigerant circulates in the following order of a compressor, the four-way valve, an interior heat exchanger, an expansion valve, and an exterior heat exchanger and (ii) a cooling cycle in which the refrigerant circulates in the following order of the compressor, the four-way valve, the exterior heat exchanger, the expansion valve, and the interior heat exchanger. In the heating cycle, a defrost operation is performed by switching the cooling cycle from the heating cycle using the four-way valve so as to radiate heat in the exterior heat exchanger when the exterior heat exchanger is frosted (for example, see Patent Document 2).

### PRIOR ART DOCUMENT

### Patent Document

Patent Document 1: JP 2011-017474 A

Patent Document 2: JP 6-069670 A

### SUMMARY OF INVENTION

According to studies conducted by the examiners of the present disclosure, in the air conditioner for a vehicle of the above Patent Documents 1, 2, the defrost operation of the exterior heat exchanger can be performed when the exterior heat exchanger is frosted. However, in the defrost operation, a heating performance decreases, and a temperature of a conditioned air that is blown toward a passenger decreases.

In view of the foregoing matters, it is an object of the present disclosure to provide an air conditioner for a vehicle with which a passenger's sensory temperature due to air blown into a passenger compartment can be prevented from decreasing even when an exterior heat exchanger is frosted.

To achieve the above object, an air conditioner for a vehicle of the present disclosure has a compressor, an interior heat exchanger, a decompressor, an exterior heat exchanger, and a blower. The air conditioner for a vehicle has: a compressor compressing refrigerant; an interior heat exchanger heating air that flows toward a passenger compartment, by high-temperature high-pressure refrigerant discharged from the compressor; a decompressor decompressing refrigerant flowing from the interior heat exchanger; an exterior heat exchanger cooling outside air by refrigerant decompressed in the decompressor; and a blower causing an airflow passing through the interior heat exchanger, the passenger compartment being heated by air passing through the interior heat exchanger; a frosting determining section determining whether the exterior heat exchanger is frosted; and an air-volume controlling section controlling the blower to reduce an air volume passing through the interior heat exchanger when the frosting determining section determines that the exterior heat exchanger is frosted.

Furthermore, according to the air conditioner for a vehicle of the present disclosure, the air volume passing through the interior heat exchanger can be reduced in a state where the interior heat exchanger heats an inside air using the high-temperature high-pressure refrigerant when the exterior heat exchanger is frosted. Accordingly, the temperature of air after passing through the interior heat exchanger can be prevented from decreasing. Thus, the passenger's sensory temperature (i.e., the temperature of air after passing through the interior heat exchanger) can be prevented from decreasing.

In addition, by reducing the air volume passing through the interior heat exchanger, a pressure of high-pressure side refrigerant passing through the interior heat exchanger increases. Then, a pressure of low-pressure side refrigerant passing through the exterior heat exchanger increases. Accordingly, a temperature of low-pressure side refrigerant passing through the exterior heat exchanger increases, and thereby a frosting of the exterior heat exchanger can be delayed.

### BRIEF DESCRIPTION OF DRAWINGS

FIG. 1 is a diagram illustrating an entire configuration of an air conditioner for a vehicle according to an embodiment.

FIG. 2 is a diagram illustrating an electric configuration of the air conditioner for a vehicle according to the embodiment.

FIG. 3 is a flow chart regarding a control procedure of an electric control device shown in FIG. 2.

FIG. 4 is a control map used in the control procedure of the electric control device.

### DESCRIPTION OF EMBODIMENTS

An embodiment of the present disclosure will be described hereafter referring to drawings.

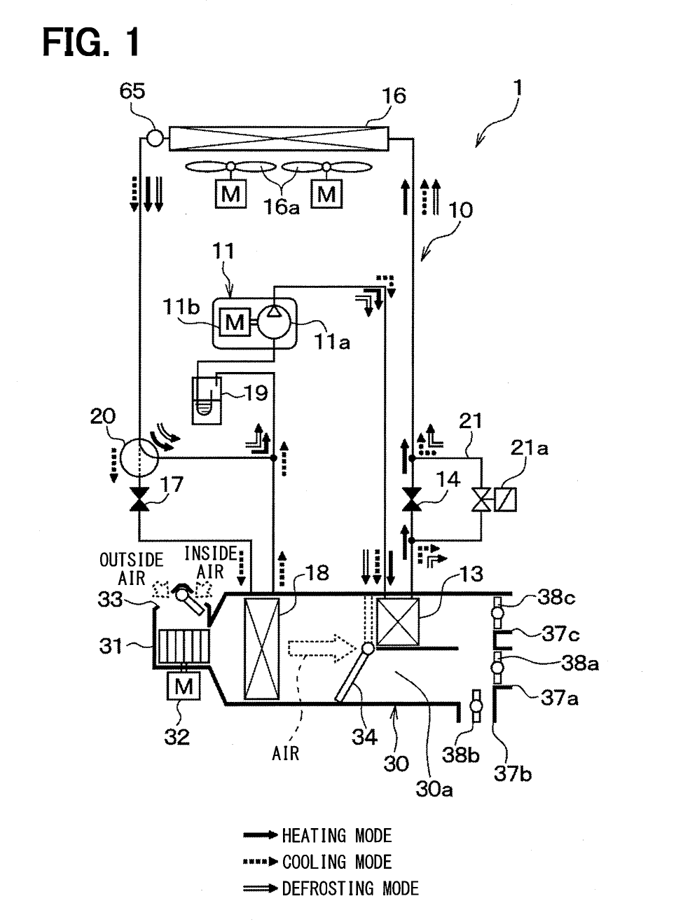

A schematic configuration of an air conditioner for a vehicle 1 according to the present embodiment of the present disclosure is shown in FIG. 1. The air conditioner for a vehicle 1 is for an electric vehicle or the like and has a refrigerant cycle device 10 for cooling or heating a passenger compartment.

A compressor (e.g., an electric compressor) 11 is disposed in the refrigerant cycle device 10. The electric compressor 11 is arranged under the food (i.e., in an engine compartment). The electric compressor 11 has a compressing device 11a and an electric motor 11b. The electric motor 11b operates the compressing device 11a. The compressing device 11a compresses and discharges refrigerant by a rotating force that is output from the electric motor 11b. As the compressing device 11a of the present embodiment, for example, a scroll type compressing device or a rotary type compressing device is used.

A heating heat exchanger 13 is disposed in the refrigerant cycle device 10. The heating heat exchanger 13 is an interior heat exchanger heating air after passing through a cooling heat exchanger 18 by high-temperature high-pressure refrigerant discharged from the electric compressor 11.

An expansion valve 14 is disposed in the refrigerant cycle device 10. The expansion valve 14 is a decompressor decompressing high-pressure refrigerant flowing from the heating heat exchanger 13.

A refrigerant bypass passage 21 is disposed between an inlet and an outlet of the expansion valve 14 such that the high-pressure refrigerant flowing from the heating heat exchanger 13 flows to bypass the expansion valve 14. A bypass valve 21a is disposed in an intermediate portion of the refrigerant bypass passage 21. The bypass valve 21a is an electric valve operated by an electric actuator to open or close the refrigerant bypass passage 21.

An exterior heat exchanger 16 is disposed in the refrigerant cycle device 10. The exterior heat exchanger 16 is arranged under the hood (i.e., in the engine compartment). In the exterior heat exchanger 16, refrigerant after passing through the expansion valve 14 (or the bypass valve 21a) exchanges heat with air (i.e., outside air) that is from an outside of the passenger compartment and blown through an electric blower 16a. The electric blower 16a blows air toward the exterior heat exchanger 16.

An expansion valve 17, an accumulator 19, and a three-way valve 20 are disposed in the refrigerant cycle device 10.

The three-way valve 20 is an electric valve that causes the exterior heat exchanger 16 to communicate with one of the expansion valve 17 and the accumulator 19, and causes the exterior heat exchanger 16 to be shut from the other one of the expansion valve 17 and the accumulator 19.

The expansion valve 17 is a decompressor expanding refrigerant after passing through the three-way valve 20. The accumulator 19 separates refrigerant after passing through the three-way valve 20 (or the cooling heat exchanger 18) into vapor-phase refrigerant and liquid-phase refrigerant.

An interior air-conditioning unit 30 is disposed in the air conditioner for a vehicle 1. The interior air-conditioning unit 30 includes an air-conditioning case 31 that therein has a passage through which air after passing an inside-outside switching unit 33 flows toward the passenger compartment.

The inside-outside switching unit 33 adjust an air-volume ratio between an inside air introduced into the air-conditioning case 31 from an inside-air introducing port and outside air introduced into the air-conditioning case 31 from an outside-air introducing port by using an inside-outside switching door.

A blower (e.g., an electric blower) 32 is disposed on a downstream side of the inside-outside switching unit 33 in a flow direction of air in the air-conditioning case 31. In the air-conditioning case 31, the electric blower 32 causes an airflow flowing toward the passenger compartment.

The cooling heat exchanger 18 is disposed on a downstream side of the electric blower 32 in the flow direction of air in the air-conditioning case 31. The cooling heat exchanger 18 is a cooling heat exchanger in which air blown by the electric blower 32 is cooled by refrigerant after passing through the expansion valve 17.

The heating heat exchanger 13 is disposed on a downstream side of the cooling heat exchanger 18 in the flow direction of air in the air-conditioning case 31. The heating heat exchanger 13 heats air after passing through the cooling heat exchanger 18 by refrigerant.

A bypass passage 30a is provided on a lateral side of the heating heat exchanger 13 in the air-conditioning case 31. The bypass passage 31a is a passage in which air after passing through the cooling heat exchanger 18 flows to bypass the heating heat exchanger 13.

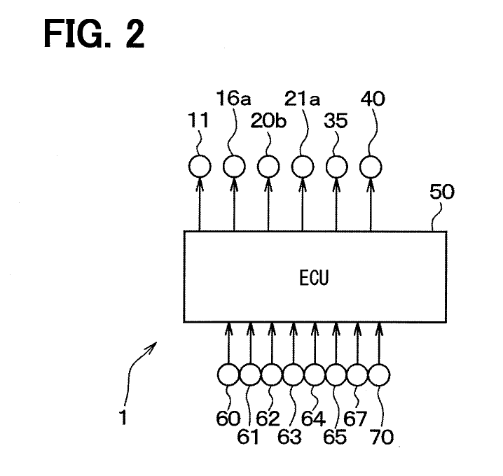

An air mix door 34 is disposed on an upstream side of the heating heat exchanger 13 in the air-conditioning case 31. The air mix door 34 is supported to be rotatable relative to the air-conditioning case 31. The air mix door 34 rotates to adjust a temperature of air that is blown into the passenger compartment by changing a ratio between a volume of air flowing from the cooling heat exchanger 18 to the heating heat exchanger 13 and a volume of air flowing from the cooling heat exchanger 18 to the bypass passage 30a. The air mix door 34 is operated by a servo motor 35 (see FIG. 2).

A face opening 37a, a foot opening 37b, and a defroster opening 37c, from which mixed air of air after passing through the heating heat exchanger 13 and air after flowing thorough the bypass passage 30a is blown into the passenger compartment, are provided on a most downstream side in the air-conditioning case 31.

The face opening 37a blows air for air conditioning toward an upper body of the passenger. The foot opening 37b blows air for air conditioning toward a lower body of the passenger. The defroster opening 37c blows air for air conditioning toward an inner surface of a windshield.

A face door 38a is disposed in the air-conditioning case 31 and supported to be capable of opening or closing the face opening 37a. A foot door 38b is disposed in the air-conditioning case 31 and supported to be capable of opening or closing the foot opening 37b. A defroster door 38c is disposed in the air-conditioning case 31 and supported to be capable of opening or closing the defroster opening 37c.

The face door 38a, the foot door 38b, and the defroster door 38c are operated by a servo motor 40 (see FIG. 2) through a link mechanism to be open or closed independently.

An electric configuration of the air conditioner for a vehicle 1 of the present embodiment will be described hereafter referring to FIG. 2.

The air conditioner for a vehicle 1 has an electric control device 50. The electric control device 50 is a well-known electric control device constituted by a microcomputer, a memory, or the like.

The electric control device 50 performs an air-conditioning control procedure for an air conditioning in the passenger compartment. In the air-conditioning control procedure, the electric control device 50 controls the electric compressor 11, the electric blower 16a, the three-way valve 20, the bypass valve 21a, and the servo motors 35, 40, separately, based on output signals from an inside air sensor 60, an outside air sensor 61, a solar radiation sensor 62, a refrigerant pressure sensor 63, a heat-exchanger temperature sensor 64, a refrigerant temperature sensor 65, a refrigerant pressure sensor 66, a vehicle speed sensor 67, and a temperature setting device 70.

The inside air sensor 60 detects an air temperature (i.e., an inside-air temperature) of air inside the passenger compartment. The outside air sensor 61 detects an air temperature (i.e., an outside-air temperature) of air outside the passenger compartment. The solar radiation sensor 62 detects an amount of solar radiation at an inside of the passenger compartment. The refrigerant pressure sensor 63 detects a pressure of refrigerant after passing through the heating heat exchanger 13. The heat-exchanger temperature sensor 64 detects a temperature of the exterior heat exchanger 16. The refrigerant temperature sensor 65 detects a temperature of refrigerant after passing through the exterior heat exchanger 16. The refrigerant pressure sensor 66 detects a refrigerant pressure (i.e., a high-pressure-side refrigerant pressure) Ph of refrigerant discharged from the electric compressor 11. The refrigerant pressure sensor 66 is located between a refrigerant outlet of the electric compressor 11 and a refrigerant inlet of the heating heat exchanger 13. The vehicle speed sensor 67 detects a vehicle speed of the vehicle. The temperature setting device 70 is a switch setting a set value Tset for an air temperature inside the passenger compartment.

An operation of the air conditioner for a vehicle 1 of the present embodiment will be described hereafter.

The electric control device 50 calculates a target air temperature TAO based on a detection inside-air temperature Tr detected by the inside air sensor 60, a detection outside-air temperature Tam detected by the outside air sensor 61, a detection solar-radiation amount Ts detected by the solar radiation sensor 62, and the set temperature Tset set by the temperature setting device 70. The target air temperature TAO is a target air temperature of air that is required to be blown from the outlets 37a, 37b, 37c to maintain the detection inside-air temperature Tr at the set temperature Tset.

In addition, the electric control device 50 operates a cooling mode or a heating mode based on the target air temperature TAO. The electric control device 50 operates a defrosting mode when the detection outside-air temperature Tam is lower than or equal to a threshold value, for example, while a battery for traveling the vehicle is charged (or while a pre-air-conditioning is performed). The pre-air-conditioning is for adjusting a temperature inside the passenger compartment before the passenger gets in the vehicle. The cooling mode, the heating mode, and the defrosting mode will be described, respectively, hereafter.

(Cooling Mode)

The electric control device 50 operates the bypass valve 21 a to open the refrigerant bypass passage 21. The three-way valve 20 causes the expansion valve 17 to communicate with the exterior heat exchanger 16, and causes the accumulator 19 to be shut from the exterior heat exchanger 16. Further, the electric compressor 11 is operated to compress and discharge refrigerant. The refrigerant discharged from the electric compressor 11 circulates as shown by a chain line arrow in FIG. 1.

Specifically, high-temperature high-pressure refrigerant discharged from the electric compressor 11 passes through the heating heat exchanger 13, the refrigerant bypass passage 21, the exterior heat exchanger 16, and the three-way valve 20, and then, the high-temperature high-pressure refrigerant is decompressed in the expansion valve 17. Refrigerant after being decompressed in the expansion valve 17 absorbs heat in the cooling heat exchanger 18 from air temperature of air blown from the electric blower 32. Refrigerant after absorbing heat is separated into vapor-phase refrigerant and liquid-phase refrigerant in the accumulator 19, and the vapor-phase refrigerant is drawn into the electric compressor 11.

In the interior air-conditioning unit 30, the electric blower 32 draws inside air (or outside air) from the inside-outside switching unit 33 and blows the air. Air blown from the electric blower 32 is cooled in the cooling heat exchanger 18 by refrigerant. Air after passing through the cooling heat exchanger 18 is divided by the air mix door 34 into air to flow in the bypass passage 30a and air to flow in the heating heat exchanger 13.

The air to flow in the heating heat exchanger 13 is heated in the heating heat exchanger 13 by refrigerant. The air heated in the heating heat exchanger 13 and the air after flowing through the bypass passage 30a are mixed and blown into the passenger compartment from the openings 37a, 37b, 37c.

The electric control device 50 controls a rotation speed of the electric compressor 11 such that the detection pressure Ph detected by the refrigerant pressure sensor 66 approaches a target refrigerant pressure. The detection pressure Ph and a temperature of refrigerant passing through the cooling heat exchanger 18 are in a correspondence relation. Accordingly, an amount of refrigerant discharged from the electric compressor 11 is controlled such that the temperature Te of air after passing through the cooling heat exchanger 18 approaches a target air temperature TEO. The target air temperature TEO is a target temperature of air after passing through the cooling heat exchanger 18.

The electric control device 50 controls an opening degree of the air mix door 34 through the servo motor 35 such that a temperature of air blown from the openings 37a, 37b, 37c approaches the target air temperature TAO.

(Defrosting Mode)

The electric control device 50 operates the bypass valve 21a to open the refrigerant bypass passage 21. The three-way valve 20 causes the expansion valve 17 to be shut from the exterior heat exchanger 16, and causes the accumulator 19 to communicate with the exterior heat exchanger. Further, the electric compressor 11 is operated to compress and discharge refrigerant. Refrigerant discharged from the electric compressor 11 circulates as shown by a double line arrow in FIG. 1.

Specifically, high-temperature high-pressure refrigerant discharged from the electric compressor 11 passes through the heating heat exchanger 13, the refrigerant bypass passage 21, the exterior heat exchanger 16, and the three-way valve 20, and then, the refrigerant is separated into vapor-phase refrigerant and liquid-phase refrigerant in the accumulator 19. Subsequently, the vapor-phase refrigerant is drawn into the electric compressor 11.

The exterior heat exchanger 16 is heated by the refrigerant when the refrigerant passes through the exterior heat exchanger 16. Accordingly, a frost formed on the exterior heat exchanger 16 melts. In the result, the exterior heat exchanger 16 can be defrosted.

(Heating Mode)

The electric control device 50 operates the bypass valve 21 a to close the refrigerant bypass passage 21. The three-way valve causes the expansion valve 17 to be shut from the exterior heat exchanger 16, and causes the accumulator 19 to communicate with the exterior heat exchanger 16. Further, the electric compressor 11 is operated to compress and discharge refrigerant. Refrigerant compressed in the electric compressor 11 circulates as shown by a solid line arrow in FIG. 1.

Specifically, high-temperature high-pressure refrigerant discharged from the electric compressor 11 passes through the heating heat exchanger, and then, the refrigerant is decompressed in the expansion valve 14. Refrigerant decompressed in the expansion valve 14 flows to the exterior heat exchanger 16. In the exterior heat exchanger 16, the refrigerant absorbs heat from outside air that is blown from the electric blower 16a. Refrigerant after absorbing heat is separated into vapor-phase refrigerant and liquid-phase refrigerant in the accumulator 19 after passing through the three-way valve 20. The vapor-phase refrigerant is drawn into the electric compressor 11.

In the interior air-conditioning unit 30, the electric blower 32 draws inside air (or outside air) that is drawn from the inside-outside switching unit 33 and blows the air. Air blown from the electric blower 32 passes through the cooling heat exchanger 18.

The electric control device 50 controls the air mix door 34 through the servo motor 35 such that an inlet of the bypass passage 30a is fully closed and the refrigerant inlet of the heating heat exchanger 13 is fully open.

Accordingly, all air after passing through the cooling heat exchanger 18 is heated in the heating heat exchanger 13 and blown from the openings 37a, 37b, 37c.

The electric control device 50 controls a rotation speed of the electric compressor 11 such that a temperature (i.e., an actual temperature) Tv of air after passing through the heating heat exchanger 13 approaches a target air temperature TVO.

The temperature Tv of air after passing through the heating heat exchanger 13 is calculated based on the detection pressure detected by the refrigerant pressure sensor 63. That is, the temperature Tv and the detection pressure are in a correspondence relation. The target air temperature TVO may be the same value as the target air temperature TAO or may be a correction value corrected based on the target air temperature TAO.

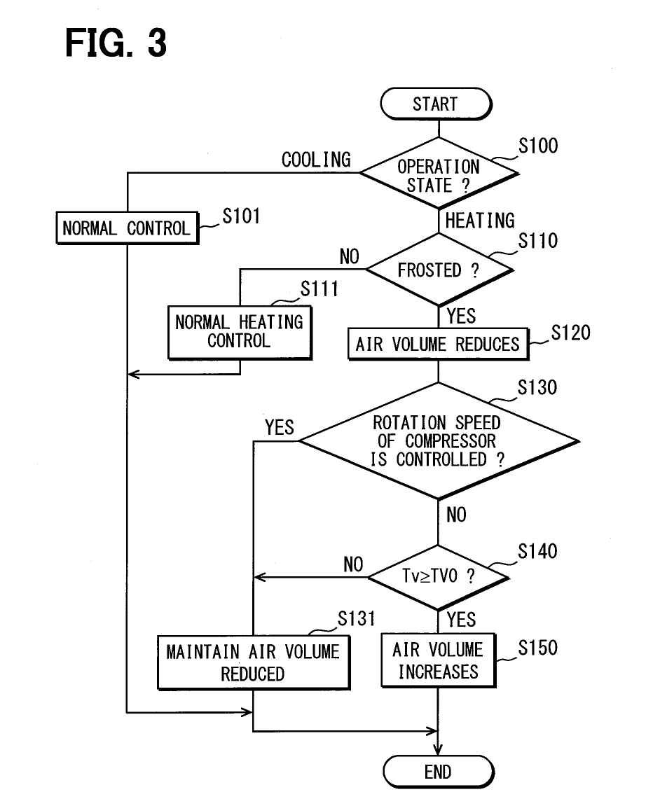

As described above, in the heating mode, the electric control device 50 performs a heating air-volume control procedure to reduce an air volume of air blown from the electric blower 32 such that a passenger's sensory temperature is prevented from decreasing due to air that is blown into the passenger compartment while the exterior heat exchanger 16 is frosted. The heating air-volume control procedure will be described hereafter referring to FIG. 3.

The electric control device 50 performs the heating air-volume control procedure in accordance with a flow chart shown in FIG. 3.

At S100, it is determined whether the cooling or the heating is performed.

When it is determined that the cooling is performed, a normal operation as the cooling is maintained (S101). On the other hand, when it is determined that the heating is performed, it is determined whether the exterior heat exchanger 16 is frosted at S110 (i.e., a frosting determining section). Specifically, it is determined whether the exterior heat exchanger 16 is frosted by determining whether a detection temperature of refrigerant detected by the refrigerant temperature sensor 65 is lower than a threshold value.

When the detection temperature detected by the refrigerant temperature sensor 65 is higher than or equal to the threshold value, it is determined to be NO at S110 as the exterior heat exchanger 16 is not frosted, and a normal heating operation is maintained (S111).

When the normal operation as the cooling or the heating is performed, an air volume to be blown by the electric blower 32 is determined based on the target air temperature TAO. For example, the air volume to be blown by the electric blower 32 is set at a minimum volume when the target air temperature TAO is in an intermediate temperature range, and the air volume to be blown by the electric blower 32 is set at a maximum volume when the target air temperature TAO is in a high temperature range (or a low temperature range).

On the other hand, when the detection temperature detected by the refrigerant temperature sensor 65 is lower than the threshold value, it is determined to be YES at S110 as the exterior heat exchanger 16 is frosted. In this case, the air volume to be blown by the electric blower 32 is reduced at S120 (i.e., an air-volume controlling section). Accordingly, an air volume blown from the openings 37a, 37b, 37c through the heating heat exchanger 13 is reduced. Specifically, the air volume is controlled to maintain a temperature of air to be blown toward the passenger at a body temperature (e.g., higher than or equal to 40° C.).

Subsequently, at S130 (i.e., a rotation-speed-control determining section), it is determined whether a rotation-speed control of the compressor that controls a rotation speed of the electric compressor 11 is performed.

The rotation-speed control of the compressor is a control procedure in which the rotation speed of the electric compressor 11 is controlled to be lower than a specified rotation speed when a detection vehicle speed detected by the vehicle speed sensor 67 is lower than a specified speed. The rotation-speed control of the compressor is performed to prevent the passenger from feeling uncomfortable due to an operation noise of the electric compressor 11.

When it is determined to be YES at S130 as the rotation-speed control of the compressor is performed, a state in which the air volume to be blown by the electric blower 32 has been reduced is maintained at S131.

When it is determined to be NO at S130 as the rotation-speed control of the compressor is not performed, it is determined whether the temperature (i.e., the actual temperature) Tv of air after passing through the heating heat exchanger 13 is lower than the target air temperature TVO at S140 (i.e., a temperature determining section). The target air temperature TVO is a temperature at which the passenger feels warm. That is, it is determined whether the passenger feels warm due to the air after passing through the heating heat exchanger 13.

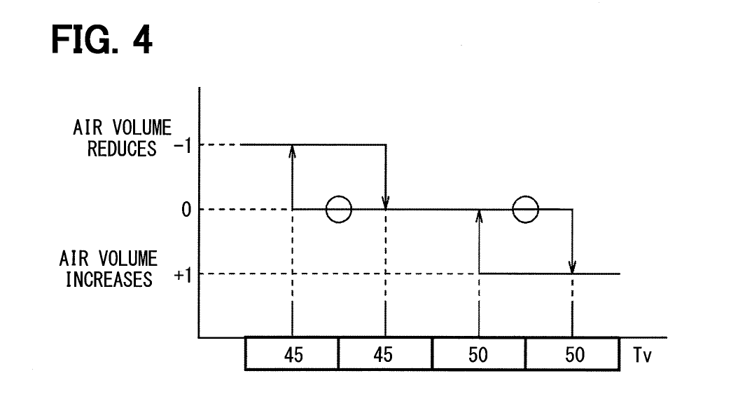

In the present embodiment, a hysteresis property is set in a determination at S140 as shown in a control map of FIG. 4 by considering a hunting of the temperature Tv in the air-volume control. Accordingly, a first target air temperature and a second target air temperature are used as the target air temperature TVO at S140. The first target air temperature is set to be lower than the second target air temperature. For example, in the control map of FIG. 4, the first target air temperature is set at 45° C., and the second target air temperature is set at 50° C.

When the temperature Tv becomes lower than the first target air temperature at S140, the control procedure advances to S131 (i.e., a control-continuation determining section), and the state in which the air volume to be blown by the electric blower 32 has been reduced is maintained.

On the other hand, when the temperature Tv increases and becomes higher than or equal to the second target air temperature, the control procedure advances to S150, and the air volume to be blown by the electric blower 32 is increased.

As described above, in the present embodiment, when the detection temperature detected by the refrigerant temperature sensor 65 is lower than the threshold value in the heating operation, and when it is determined to be YES at S110 as the exterior heat exchanger 16 is frosted, the electric control device 50 reduces the air volume to be blown by the electric blower 32 at S120. Accordingly, the air volume blown from the openings 37a, 37b, 37c through the exterior heat exchanger 16 is reduced.

Therefore, when the exterior heat exchanger 16 is frosted, the air volume passing through the heating heat exchanger 13 can be reduced in a state where the heating heat exchanger (i.e., the interior heat exchanger) 13 heats inside air by high-temperature high-pressure refrigerant.

Here, in Patent Document 2, when the exterior heat exchanger is frosted, a heating cycle is set to a cooling cycle by a four-way valve, and a defrost operation is performed such that a blower in a passenger compartment is controlled to adjust an air volume blown from the blower through the heating heat exchanger 13.

In contrast, in the present embodiment, when the exterior heat exchanger 16 is frosted, the air volume passing through the heating heat exchanger 13 can be reduced in the state where the heating heat exchanger 13 heats inside air by high-temperature high-pressure refrigerant. Accordingly, the air volume passing through the interior heat exchanger 13 can be reduced without performing the defrost operation. Thus, the temperature Tv can be prevented from decreasing. Therefore, the passenger's sensory temperature (i.e., the passenger's sensory temperature due to air after passing through the heating heat exchanger 13) can be prevented from decreasing.

Furthermore, by reducing the air volume passing through the heating heat exchanger 13, a pressure of high-pressure-side refrigerant in the refrigerant cycle device 10 increases. Accordingly, a pressure of low-pressure-side refrigerant in the refrigerant cycle device 10 increases. Thus, a temperature of low-pressure-side refrigerant passing through the exterior heat exchanger 16 increases. Therefore, a frosting of the exterior heat exchanger can be delayed.

In the present embodiment, it is determined whether the exterior heat exchanger 16 is frosted by using the refrigerant temperature (i.e., the temperature of refrigerant after passing through the exterior heat exchanger 16) that is detected by the refrigerant temperature sensor 65. However, the present disclosure is not limited to this example. It may be determined whether the exterior heat exchanger 16 is frosted by determining whether a detection temperature (i.e., a temperature of the exterior heat exchanger 16) detected by the heat-exchanger temperature sensor 64 is lower than a threshold value. The heat-exchanger temperature sensor 64 is a temperature sensor detecting a temperature of the exterior heat exchanger 16.

In the present embodiment, the air conditioner for a vehicle 1 is used in an electric vehicle or the like. However, the air conditioner for a vehicle 1 may be used in a hybrid vehicle.

For example, the exterior heat exchanger 16 is frosted in a hybrid vehicle having an engine for traveling the vehicle, the air volume blown from the opening 37a, 37b, 37c after passing through the heating heat exchanger 13 may be reduced by reducing the air volume that is blown by the electric blower 32 at S120 shown in FIG. 3 before the engine for traveling the vehicle is operated. Accordingly, the passenger's sensory temperature due to air blown into the passenger compartment while the exterior heat exchanger 16 is frosted can be prevented from decreasing without using coolant for the engine for traveling the vehicle.

Moreover, the air conditioner for a vehicle 1 of the present embodiment is not limited to be used in a vehicle such as an electric vehicle or a hybrid vehicle, and the air conditioner for a vehicle 1 of the present embodiment may be used for an electric train, a train, or the like.

In the present embodiment, an example of calculating the temperature Tv based on the detection pressure detected by the refrigerant pressure sensor 63. However, the temperature Tv may be calculated by using a temperature sensor that detects the temperature Tv.

In the present embodiment, when the air volume to be blown by the electric blower 32 is reduced at S120 in FIG. 3, an auxiliary heat source such as a stealing heater, a seat heater, or a console heater that heats a part of a body of the passenger may be operated (i.e., ON) automatically. In the result, the passenger can feel warm. In the present embodiment, it should be understood that components (including various detecting sections) are unnecessary unless it is explicitly mentioned to be necessary or it is concerned to be obviously necessary in principle.

1. An air conditioner for a vehicle, comprising:
a compressor compressing refrigerant;
an interior heat exchanger heating air that flows toward a passenger compartment, by high-temperature high-pressure refrigerant discharged from the compressor;
a decompressor decompressing refrigerant flowing from the interior heat exchanger;
an exterior heat exchanger cooling outside air by refrigerant decompressed in the decompressor; and
a blower causing an airflow passing through the interior heat exchanger, the passenger compartment being heated by air passing through the interior heat exchanger;
a frosting determining section determining whether the exterior heat exchanger is frosted; and
an air-volume controlling section controlling the blower to reduce an air volume passing through the interior heat exchanger when the frosting determining section determines that the exterior heat exchanger is frosted.

2. The air conditioner for a vehicle according to claim 1, wherein
the compressor is an electric compressor having a compressing device compressing the refrigerant by a rotating force that is output from an electric motor.

3. The air conditioner for a vehicle according to claim 1, further comprising:
a rotation-speed-control determining section determining whether a rotation-speed control is performed in which a rotation speed of a motor of the compressor is decreased; and
a control-continuation determining section controlling the blower to maintain a state in which the air volume passing through the interior heat exchanger has been reduced, when the rotation-speed determining section determines that the rotation-speed control is performed after the air-volume controlling section controls the blower to reduce the air volume passing through the interior heat exchanger.

4. The air conditioner for a vehicle according to claim 2, further comprising
a temperature determining section determining whether a temperature of air after passing through the interior heat exchanger is higher than or equal to a target air temperature, wherein
the control-continuation determining section controls the blower to maintain a state in which the air volume passing through the interior heat exchanger has been reduced when (i) the rotation-speed determining section determines that the rotation-speed controls is not performed and (ii) the temperature determining section determines that the temperature of air after passing through the interior heat exchanger is lower than the target air temperature, after the air-volume controlling section controls the blower to reduce the air volume passing through the interior heat exchanger.
